(19) United States
(12) Patent Application Publication
(10) Pub. No.: US 2017/0297413 A9
(43) Pub. Date: Oct. 19, 2017

(54) AUTOMOTIVE HVAC SYSTEM

(71) Applicants: DENSO International America, Inc., Southfield, MI (US); DENSO CORPORATION, Kariya-city (JP)

(72) Inventors: Christopher WISNIEWSKI, Ann Arbor, MI (US); Michael POLUS, Belleville, MI (US); Kristie SWAILES, Ortonville, MI (US)

(73) Assignees: DENSO International America, Inc., Southfield, MI (US); DENSO CORPORATION, Kariya-city (JP)

(21) Appl. No.: 15/074,393

(22) Filed: Mar. 18, 2016

Related U.S. Application Data
(60) Provisional application No. 62/270,231, filed on Dec. 21, 2015.
(60) Provisional application No. 62/137,877, filed on Mar. 25, 2015.

(51) Int. Cl. B60H 1/00; B60S 1/02

(52) U.S. Cl. CPC B60H 1/00842; B60H 1/00678; B60S 1/023; B60H 1/00021; B60H 2001/00092; B60H 2001/00721; B60H 2001/00707

(57) ABSTRACT

A vehicle heating, ventilation, and air cooling (HVAC) system that includes a module, an evaporator, and a heater core; the module defines a defrost outlet, a side window outlet, a front face outlet, and a front foot outlet. The evaporator and heater core are both housed within the module. The defrost outlet being open and closed by a defrost door, the side window outlets being open and closed by a plurality of demist doors. The defrost door and demist doors share a common shaft, a torsion spring around the shaft allows the defrost door to remain offset from the demist doors.

### CROSS-REFERENCED TO RELATED APPLICATIONS

This application claims the benefit of U.S. Provisional Application No. 62/137,877, filed on Mar. 25, 2015, and U.S. Provisional Application No. 62/270,231, filed on Dec. 21, 2015, the disclosures of which are incorporated herein by reference in its entirety.

### FIELD

The present disclosure relates to heating, ventilating, and air-conditioning (HVAC) systems in vehicles and, more particularly, relates to the defrost and demist doors.

### BACKGROUND

This section provides background information related to the present disclosure which is not necessarily prior art.

The present disclosure relates generally to automotive vehicle climate control HVAC systems, it is common to have a climate control system located within an instrument panel which provides heated or cooled air to occupants through dashboard defrost air outlets, instrument panel venting air outlets and floor directed air outlets. In a heating mode, airflow that has passed into the HVAC casing through the evaporator, which is often deactivated, is directed through the heater core by a temperature control door. In a cooling mode, the evaporator is activated and the temperature control door is positioned such that cooled airflow that has passed through the evaporator is directed around the heater core. A plurality of additional doors direct airflow out from within the casing to various areas within a passenger cabin of the motor vehicle. For example, a face outlet door controls airflow exiting the HVAC casing towards an upper portion of the passenger cabin and an occupant's face. A foot outlet door controls airflow exiting the HVAC casing towards a floor of the passenger cabin and an occupant's feet. Rear outlet doors control and direct airflow to a rear of the passenger cabin.

Motor vehicle HVAC systems also often include a windshield defrost mode and a side window demist mode. With typical HVAC systems, it is not possible to control side window demist operation independent of the windshield defrost operation, and to provide constant side window demist throughout different heating modes, such as foot and face heating modes, without including an excessive number of control doors. The present teachings address these issues by providing an automobile HVAC system that provides controlled side window demist throughout various heating modes with a reduced number of control doors, which reduces costs, simplifies operation, and increases operational reliance of the HVAC system.

### SUMMARY

This section provides a general summary of the disclosure, and is not a comprehensive disclosure of its full scope or all of its features.

The present teachings provide for an automotive heating, ventilation, and air conditioning (HVAC) system that may have a casing defining a defrost outlet, a plurality of side window demist outlets, a front face outlet, and a front foot outlet. The plurality of side window demist outlets may be adjacent to the defrost outlet. An evaporator may be housed within the casing along with a heater core. A defrost door may be used to open and close the defrost outlet. A plurality of demist doors may be used to open and close a plurality of side window demist outlets. The defrost door and plurality of demist doors may rotate partially independent on a common shaft. A torsion spring may be disposed over the shaft biased against the defrost door to force the defrost door in a offset position to the plurality of demist doors.

The present teachings also provide for an automotive ventilation system that may have a HVAC module. The HVAC module may define a defrost outlet and a plurality of demist outlets that may be adjacent to the defrost outlet. A door assembly may include a defrost door, a plurality of demist doors, a shaft and a spring. The defrost door and plurality of demist doors may partially independently rotate on the shaft. The spring may be disposed around the shaft. The spring may also be engaged against the defrost door to bias the defrost door in an offset position from the plurality of demist doors.

The present teachings also provide for A vehicle HVAC module that may have a defrost outlet, a first demist outlet adjacent to the defrost outlet, a second demist outlet adjacent to the defrost outlet on the opposite side of the defrost outlet of the first demist outlet, and a door assembly. The door assembly may include a defrost door, a first demist door a second demist door, a shaft, a spring and a locking feature integrated into the shaft. The first and second demist doors may rotate together with the shaft partially independent from the defrost door. The spring may be coiled around the shaft abutting against the defrost door to bias the defrost door in an offset position from the first and second demist doors.

Further areas of applicability of the present invention will become apparent from the detailed description provided hereinafter. It should be understood that the detailed description and specific examples, while indicating the preferred embodiment of the invention, are intended for purposes of illustration only and are not intended to limit the scope of the invention.

### DRAWINGS

The drawings described herein are for illustrative purposes only of selected embodiments and not all possible implementations, and are not intended to limit the scope of the present disclosure.

FIG. 1 is a schematic representation of a vehicle having a HVAC module;

FIG. 2 is a fragmented perspective view of an automotive vehicle showing a portion of the passenger space;

FIG. 3 is a cross-section of a HVAC module;

FIG. 4 is a top view of a HVAC module;

FIG. 5 is a perspective view of the door assembly;

FIG. 6 is a view of the locking feature;

FIG. 7A is a view of the door assembly in a mode;

FIG. 7B is a view of the door assembly in a different mode;

FIG. 7C is a view of the door assembly in another different mode;

FIG. 8A is another perspective view of the door assembly;

FIG. 8B is a cross-sectional view of the door assembly; and

FIG. 9 is a view of an additional feature of the HVAC module.

Corresponding reference numerals indicate corresponding parts throughout the several views of the drawings.

### DESCRIPTION

Example embodiments will now be described more fully with reference to the accompanying drawings. The following description is merely exemplary in nature and is not intended to limit the present disclosure, application, or uses. It should be understood that throughout the drawings, corresponding reference numerals indicate like or corresponding parts and features.

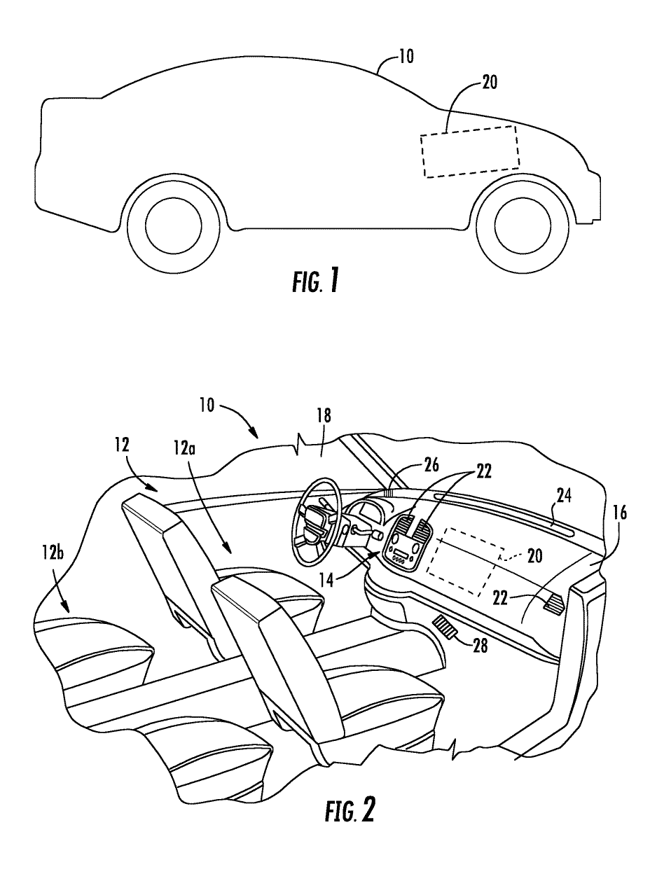

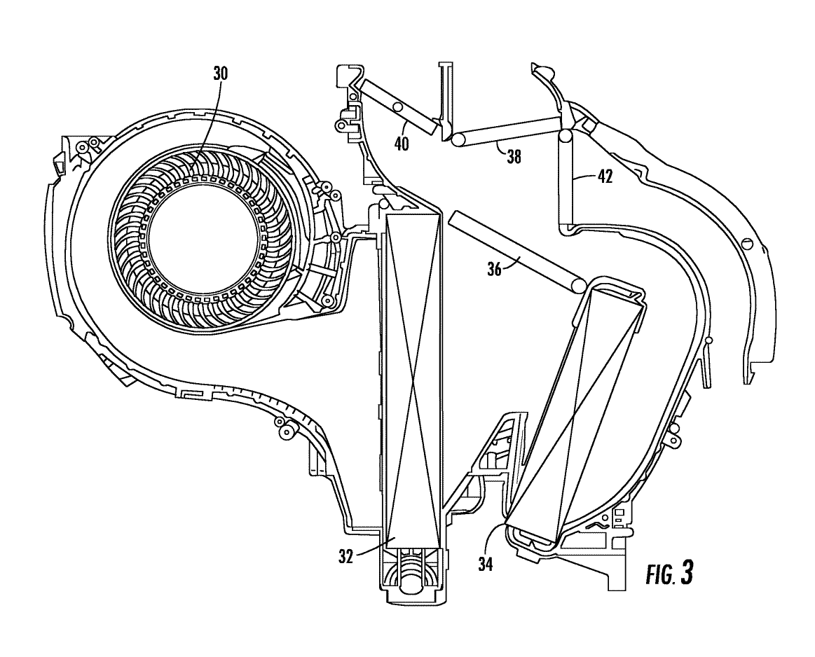

FIGS. 1 & 2 show an automotive vehicle 10 with an HVAC module or casing 20 according to the present teachings can be utilized is shown. The HVAC module 20 is part of the automotive HVAC system or automotive ventilation system and can be referred to as a vehicle HVAC module 20. Vehicle 10 includes a passenger space 12 which may have both a front passenger space 12a and a rear passenger space 12b. HVAC controls 14 allow adjustment of the operation of HVAC module 20 to provide desired flows of conditioned air. The passenger space may include instrument panel (IP) or dashboard 16 that may have a series of outlets that are fluidly connected to the HVAC module 20, the dashboard may contain center face vent outlets 22, windshield defrost vent outlet 24 and demist vent outlets 26 that are used to direct airflow to the side windows 18 of vehicle 10. The demist vent outlets 26 may also be referred to as the side window demist vent outlets. The demist vent outlets 26 may be on the top of the dashboard 16 or the side of the dashboard 16. The passenger space 12 may also contain foot vent outlets 28 that direct airflow toward a passenger's feet.

In FIG. 3, a cross-section of the HVAC module 20 is shown. The HVAC module 20 includes a blower fan 30, commonly known has a blower or an airflow generator; downstream of the blower fan 30 is an evaporator 32 or first heat exchanger, to cool the air. A heater core 34, or second heat exchanger, is used to heat the air that may flow into the passenger space 12. An air mix door 36 can be used to determine the ratio of air that flows through the heater core 34 or around/bypass the heater core 34. To control the air mode, a series of vent doors may control the amount of air flowing out of the defrost vent outlet 24, face vent outlets 22 and foot vent outlets 28. Door 38 controls the airflow directed to the face vent outlets 22, known as the face door 38. Door assembly 40, which will be described in greater detail below, controls airflow directed to the defrost vent outlet 24 and demist vent outlets 26. Door 42 controls the airflow directed to the foot vent outlets 28. It is understood in the art that vents connect the HVAC module 20 to the respective outlets 22, 24, 26, and 28, vents are not shown,

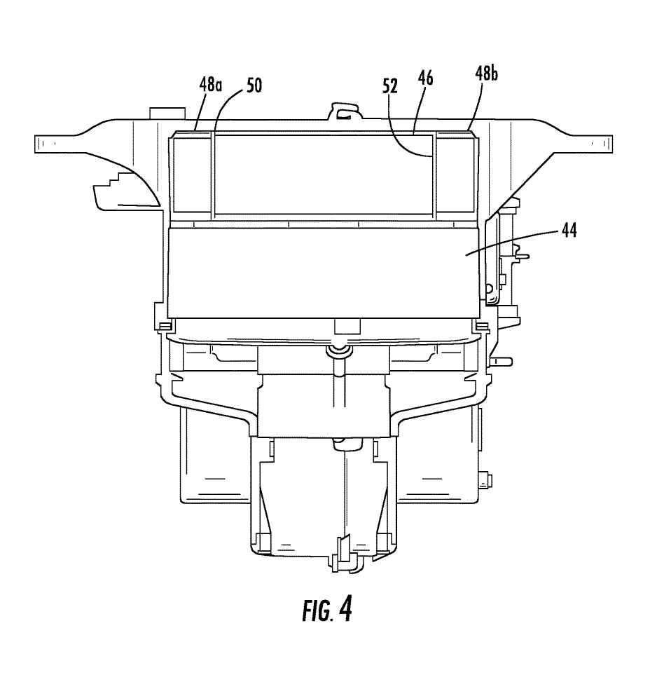

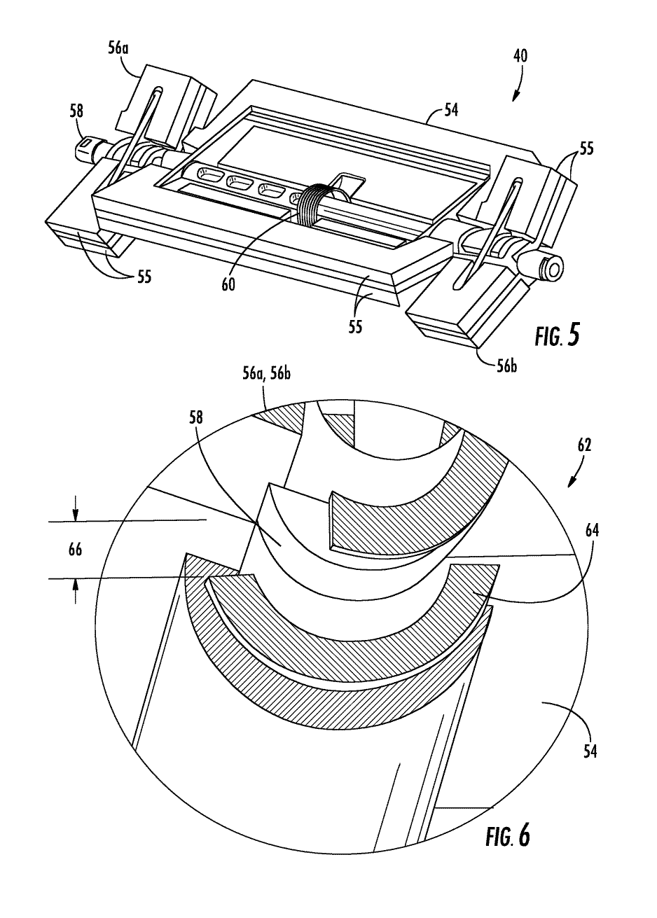

FIG. 4. displays a top view of the HVAC module 20, specifically looking at outlets of the HVAC module without doors for explanation and clarity purposes. The face outlet 44 is shown in this view right below the defrost outlet 46 and the two demist outlets 48a and 48b, also known as a first demist outlet 48a and second demist outlet 48b, also known has side window demist outlets. The demist outlets 48a and 48b are on opposite sides of the defrost outlet 46. The defrost outlet 46 is separated from demist outlets 48a and 48b by first wall 50 and second wall 52. The airflow for defrost outlet 46 and demist outlets 48a and 48b are controlled by door assembly 40 shown in an isometric view in FIG. 5. Door assembly 40 comprises a defrost door 54 and two demist doors 56a and 56b that coordinate with demist outlets 48a and 48b respectively, also known as first demist door 56a and second demist door 56b. A shaft 58 is located at the center of the door assembly and is a common shaft for the defrost door 54 and demist doors 56a, 56b and represents the axis in which the defrost door 54 and demist doors 56a, 56b rotated around. A torsion spring 60 engages the shaft 58 and the defrost door 54 and biases the defrost door rotatably offset from the demist doors 56a, 56b. Additionally door assembly 40 may include a foam seal 55 on all sides of each of the doors 54, 56a, and 56b to allow for efficient sealing against the HVAC module 20. The two demist doors 56a and 56b are interlocked onto the shaft 58 and move relative to the shaft's 58 rotation. The defrost door 54 has some partial independence of movement from the shaft 58 and the two demist doors 56a and 56b. The partial independence is from the spring 60 biasing the defrost door 54 in an offset position from the demist doors 56a, 56b; this can lead to the defrost door remaining closed while the demist doors 56a, 56b and shaft 58 rotate to allow the demist doors 56a, 56b to be partially opened. This offset is shown with the door assembly 40 in FIG. 5. However, once the demist doors 56a, 56b and shaft 58 rotate to open the demist doors 56a, 56b even further, the defrost door 54 engages locking feature 62 shown in FIG. 6, and opens as well. The locking feature 62 has a key portion 64 that is integrated to the shaft 58, or could be integrated into one of the demist doors 56a, 56b, that provides a gap 66. This gap 66 allows the shaft and demist doors 56a, 56b to rotate partially independent of the defrost door 54, at least until gap 66 is eliminated and key portion 64 engages defrost door 54. To better illustrate the features of door assembly 40, specifically the offset position of the defrost door 54, discussion of operation of HVAC module 20 is may be merited.

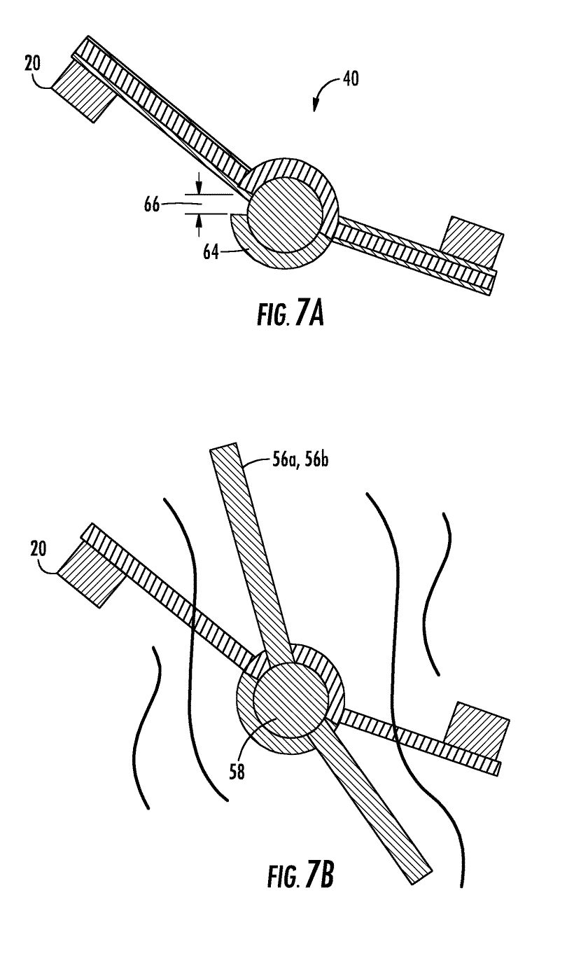

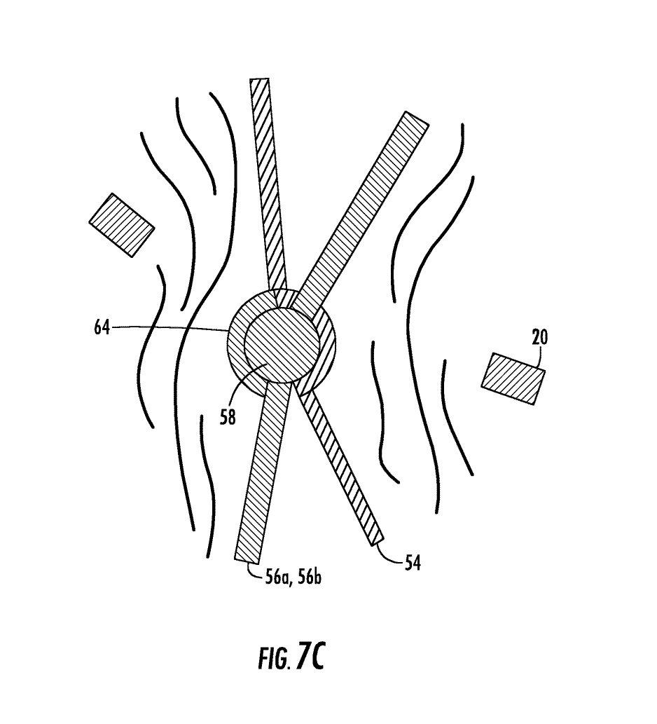

FIGS. 7A, 7B and 7C are a side view of the HVAC module 20 specifically a cross-section view of the defrost outlet 46 and demist outlets 48a, 48b with door assembly 40 in various HVAC module modes. In FIG. 7A the user may desire airflow from the face vent outlets 22, which is referred to in the art as face mode, also there is a bi-level mode that provides airflow from the face vent outlets 22 and the foot vent outlets 28 in the passenger space 12. In these modes, the door assembly 40 closes the defrost outlet 46 and demist outlets 48a, 48b, the door assembly seals against the HVAC module 20 or HVAC casing. In these modes, gap 66 is at its greatest clearance and defrost door 54 and demist doors 56a, 56b are aligned and are in a closed position. The servo motor (not shown) is rotating the shaft 58 to overcome the spring 60 force to close all the doors 54, 56a, and 56b of door assembly 40. In FIG. 7B which represents foot mode, the gap 66 map be eliminated as the demist doors 56a, 56b are opened to allow airflow to demist vent outlets 26. However, defrost door 54 is remained sealed to HVAC module 20 and offset from the demist doors position 56a, 56b. This is accomplished by torsion spring 60 forcing or biasing the defrost door 54 closed while demist doors 56a, 56b are opened. The torsion spring 60 is forcibly engaged with shaft 58 and defrost door 54, as shaft rotates to open demist doors 56a, 56b and closes gap 66, the torsion spring 60 maintains the position of defrost door 54 allowing airflow to pass through the demist outlets 48a, 48b. Use of the torsion spring 60 allows to accomplish controlling the defrost door 54 and the demist doors 56a, 56b with one servo motor (not shown) connected to either end of the shaft 58. FIG. 7C shows the door assembly 40 in foot/defrost mode or just defrost mode. These two modes require door assembly 40 to be open for the defrost outlet 46 and demist outlets 48a, 48b to provide airflow to the respective vent outlets 24, 26. Shaft 58 rotates further and key portion 64 engages defrost door 54 and opens the defrost outlet 46, the torsion spring 60 still biases the defrost door 54 to be offset from the demist doors 56a, 56b.

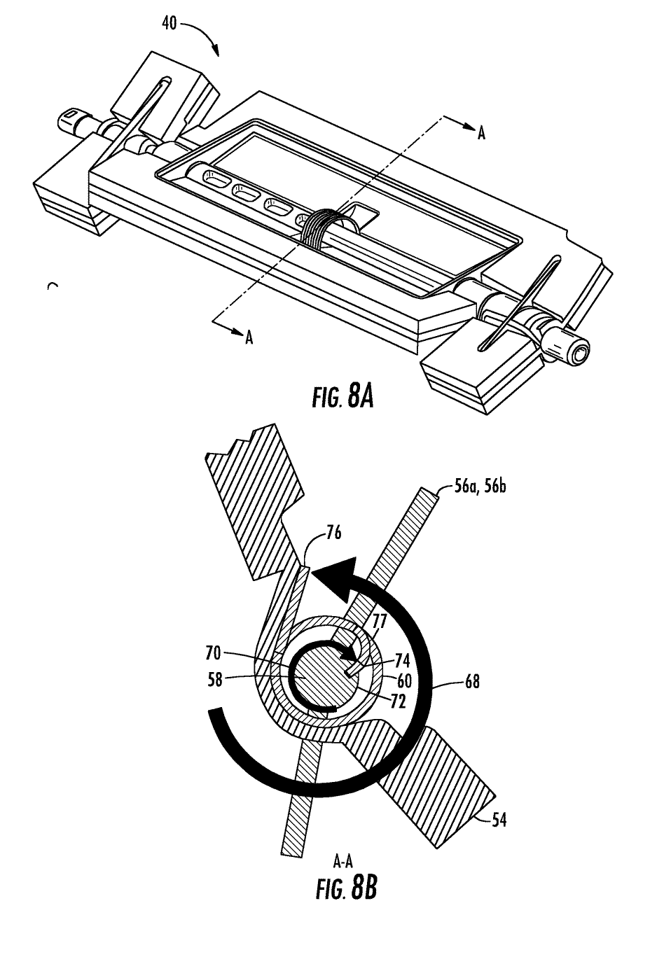

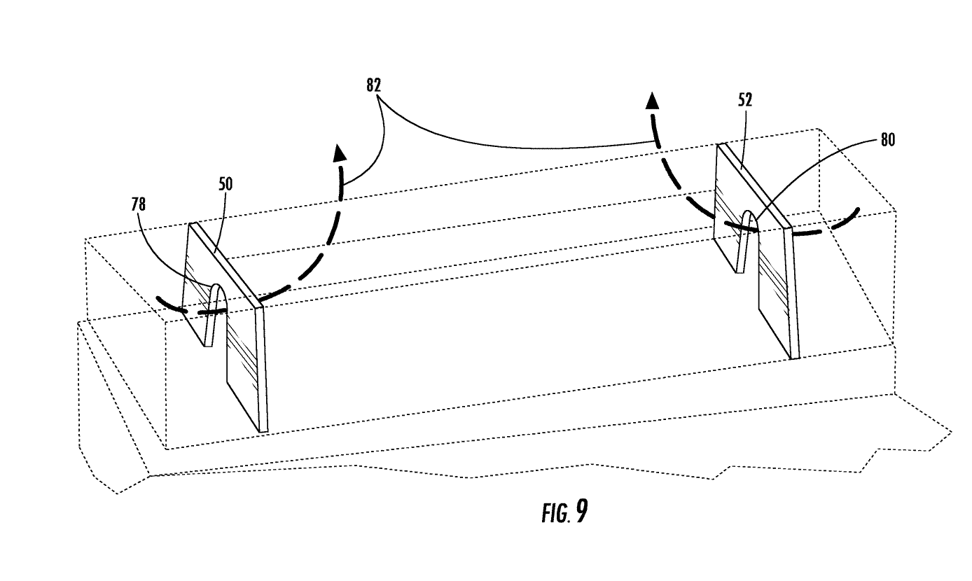

In FIGS. 8A and 8B are further clarification of the torsion spring 60 and its interaction with defrost door 54 and shaft 58. FIG. 8A displays where cross-section A-A is taken to display in FIG. 8B which will further be discussed. FIG. 8B displays the condition similar to FIG. 7B in where foot mode allows demist doors 56a, 56b to be open but requires defrost door 54 to remain shut, or to be offset from the demist doors 56a, 56b. Large arrow 68 represents the spring force, and smaller arrow 70 represents the rotation of the shaft 58. The spring 60 is engaged with shaft 58 through a groove 72 located on the shaft 58; a first end 74 of the spring 60 is inserted into the groove 72 on the shaft 58. The coil 76 of the torsion spring 60 is located around the shaft 58, a second end 77 of the spring 60 abuts the defrost door 54 and forces the defrost door 54 the direction of large arrow 68, which is opposite the rotation of the shaft 58. This spring force represented by large arrow 68 biases the defrost door 54 offset of the demist doors 56a, 56b.

Referring to FIG. 9, an additional feature that may be incorporated into the present disclosure is bypass openings 78 and 80, incorporated into walls 50 and 52, and may be referred to as a first bypass opening 78 and a second bypass opening 80. In foot mode, as shown in FIG. 7B, it may be desired to have some airflow to defrost vent outlet 24 without opening defrost door 54. While demist doors 56a and 56b are open, airflow may flow through bypass opening 78 and 80, represented by arrows 82 and out the defrost outlet 46 of the HVAC module 20.

Those skilled in the art can now appreciate from the foregoing description that the broad teachings of the present disclosure can be implemented in a variety of forms. Therefore, while this disclosure has been described in connection with particular examples thereof, the true scope of the disclosure should not be so limited since other modifications will become apparent to the skilled practitioner upon a study of the drawings, the specification and the following claims.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. An automotive heating, ventilation, and air conditioning (HVAC) system comprising:
a casing defining a defrost outlet, a plurality of side window demist outlets, a front face outlet, and a front foot outlet, wherein the plurality of side window demist outlets are adjacent to the defrost outlet;
an evaporator housed within the casing;
a heater core housed within the casing;
a defrost door to open and close the defrost outlet;
a plurality of demist doors to open and close a plurality of side window demist outlets; wherein the defrost door and plurality of demist doors rotate partially independent on a common shaft; and
a torsion spring disposed over the shaft biased against the defrost door to force the defrost door in an offset position to the plurality of demist doors.

2. The automotive HVAC system of claim 1, further comprising
a locking feature integrated on the shaft that engages the defrost door upon rotation of the shaft to open the defrost door.

3. The automotive HVAC system of claim 1, wherein the defrost door and the plurality of demist doors position is determined based on a plurality of HVAC module modes, wherein the plurality of HVAC module modes are a face mode, a bi-level mode, a foot mode, a defrost mode and a foot/defrost mode.

4. The automotive HVAC system of claim 3, wherein the HVAC module mode is in the face mode or the bi-level mode the defrost door and the plurality of demist doors are closed.

5. The automotive HVAC system of claim 3, wherein the HVAC module mode is in the foot mode the defrost door is closed or partially open and the plurality of demist doors are open.

6. The automotive HVAC system of claim 3, wherein the HVAC module mode is in the defrost mode or the foot/defrost mode the defrost door and the plurality of demist doors are open.

7. The automotive HVAC system of claim 1, wherein the plurality of demist doors are a first and a second demist door, a plurality of side window demist outlets are a first and a second side window demist outlet, the first side window demist outlet is adjacent to the defrost outlet and separated by a first wall, the second side window demist outlet is adjacent to the defrost outlet opposite the first side window demist outlet and separated by a second wall.

8. The automotive HVAC system of claim 7, further comprising a first bypass opening and a second bypass opening wherein the first bypass opening allows airflow through the first wall and the second bypass opening allows airflow through the second wall.

9. An automotive ventilation system comprising:
a HVAC module, the HVAC module defining a defrost outlet;
a plurality of demist outlets adjacent to the defrost outlet; and
a door assembly that includes a defrost door, a plurality of demist doors, a shaft and a spring, wherein the defrost door and plurality of demist doors partially independently rotate on the shaft and the spring is disposed around the shaft, the spring engaged against the defrost door to bias the defrost door in an offset position from the plurality of demist doors.

10. The automotive ventilation system according to claim 9, wherein the spring has a first end and a second end, the shaft has a groove, the first end of the spring is inserted into the groove to engage the shaft.

11. The automotive ventilation system of claim 9, further comprising
a locking feature integrated on the shaft that engages the defrost door upon rotation of the shaft to open the defrost door.

12. The automotive ventilation system of claim 9, wherein the plurality of demist doors are a first and a second demist door, a plurality of demist outlets are a first and a second demist outlet, the first demist outlet is adjacent to the defrost outlet and separated from the defrost outlet by a first wall, the second demist outlet is adjacent to the defrost outlet on an opposite side the first demist outlet and the second demist outlet is separated from the defrost outlet by a second wall.

13. The automotive ventilation system of claim 12, further comprising a first bypass opening and a second bypass opening wherein the first bypass opening allows airflow from the first demist outlet through the first wall and into the defrost outlet and the second bypass opening allows airflow from the second demist outlet through the second wall and into the defrost outlet.

14. A vehicle HVAC module comprising:
a defrost outlet;
a first demist outlet adjacent to the defrost outlet;
a second demist outlet adjacent to the defrost outlet on the opposite side of the defrost outlet of the first demist outlet; and
a door assembly that includes a defrost door, a first demist door a second demist door, a shaft, a spring and a locking feature integrated into the shaft; wherein the first and second demist doors rotate together with the shaft partially independent from the defrost door, the spring is coiled around the shaft, abutting against the defrost door to bias the defrost door in an offset position from the first and second demist doors.

15. The vehicle HVAC module of claim 14, wherein the defrost door and the first and second demist doors position is determined based on a plurality of HVAC module modes, wherein the plurality of HVAC module modes are a face mode, a bi-level mode, a foot mode, a defrost mode and a foot/defrost mode.

16. The vehicle HVAC module of claim 15, wherein the HVAC module mode is in the face mode or the bi-level mode the defrost door and the first and second demist doors are aligned in a closed position.

17. The vehicle HVAC module of claim 15, wherein the HVAC module mode is in the foot mode the defrost door is closed and the first and second demist doors are open, the defrost door offset from the first and second demist doors.

18. The vehicle HVAC module of claim 15, wherein the HVAC module mode is in the defrost mode or the foot/defrost mode, the defrost door and the first and second demist doors are open, the defrost door offset from the first and second demist doors.
